(19) United States
(12) Patent Application Publication
(10) Pub. No.: US 2021/0094502 A1
(43) Pub. Date: Apr. 1, 2021

(54) FOLDING METHOD OF SIDE AIR BAG APPARATUS AND SIDE AIR BAG APPARATUS

(71) Applicant: HYUNDAI MOBIS CO., LTD., Seoul (KR)

(72) Inventor: Kum Ho JO, Yongin-si (KR)

(21) Appl. No.: 16/984,494

(22) Filed: Aug. 4, 2020

(30) Foreign Application Priority Data
Sep. 27, 2019 (KR) 10-2019-0119637

(51) Int. Cl. B60R 21/237; B60R 21/231; B60R 21/233

(52) U.S. Cl. CPC B60R 21/237; B60R 2021/23538; B60R 21/233; B60R 21/23138

(57) ABSTRACT

Provided are a folding method of a side air bag apparatus and the side air bag apparatus. The folding method of the side air bag apparatus includes the steps of: forming an upper tuck-in portion and a lower tuck-in portion by tucking in one side of an upper chamber and one side of a lower chamber of a cushion part, respectively, the upper chamber and the lower chamber being divided by a preset reference part; forming an inboard folding portion by folding the upper chamber toward the preset reference part in a state in which the upper tuck-in portion has been formed; and forming a rolling portion by rolling, in a direction of an inflator, the upper chamber in a state in which the inboard folding portion has been formed and the lower chamber in a state in which the lower tuck-in portion has been formed.

### CROSS-REFERENCE TO RELATED APPLICATION

This application claims priority from and the benefit of Korean Patent Application No. 10-2019-0119637, filed on Sep. 27, 2019, which is hereby incorporated by reference for all purposes as if set forth herein.

### BACKGROUND

### Field

Exemplary embodiments of the present disclosure relate to a folding method of a side air bag apparatus and the side air bag apparatus, and more particularly, to a folding method of a side air bag apparatus and the side air bag apparatus, by which it is possible to control a deployment speed of an air bag cushion part according to the size of a vehicle.

### Discussion of the Background

In general, various types of air bags are installed in a vehicle to protect passengers from collisions. Among such air bags, a side air bag is deployed between a door of the vehicle and a passenger so as to protect the passenger by substantially preventing a direct collision with the door and a door glass that enter a vehicle interior during a side collision.

In the side collision, a distance between a passenger and a collision point is shorter than that in a head-on collision so that door intrusion and passenger collision situations are terminated in a short time. Thus, a fast air bag deployment speed is required. Furthermore, it is advantageous for the protection of passengers that a pressure holding time in an air bag cushion is kept long.

When a cushion shape of such a side air bag and an inflator have substantially the same specifications, performance deviation occurs according to a difference in a space between a vehicle seat and a door trim. For example, when a side air bag with no problem in a midsize vehicle or a full-size vehicle is applied to a small vehicle, the side air bag is incompletely deployed between the vehicle and a passenger's arm due to a narrow deployment space for the side air bag in the small vehicle, resulting in problems in that the passenger does not lift his/her arm and is injured.

### SUMMARY

Various embodiments are directed to providing a folding method of a side air bag apparatus and the side air bag apparatus, by which it is possible to control a deployment speed of an air bag cushion part according to the size of a vehicle.

Problems to be solved by the present disclosure are not limited to the aforementioned problem(s), and other unmentioned problems will be clearly understood by those skilled in the art from the following description.

In an embodiment, a folding method of a side air bag apparatus includes the steps of: forming an upper tuck-in portion and a lower tuck-in portion by tucking in one side of an upper chamber and one side of a lower chamber of a cushion part, respectively, the upper chamber and the lower chamber being divided by a preset reference part; forming an inboard folding portion by folding the upper chamber toward the preset reference part in a state in which the upper tuck-in portion has been formed; and forming a rolling portion by rolling, in a direction of an inflator, the upper chamber in a state in which the inboard folding portion has been formed and the lower chamber in a state in which the lower tuck-in portion has been formed.

In the present disclosure, the preset reference part may be a diaphragm part or a central part, when the cushion part has a two-chamber structure, the cushion part may be divided into an upper chamber and a lower chamber by the diaphragm part, and when the cushion part has a one-chamber structure, the cushion part may be divided into an upper chamber and a lower chamber by the central part.

In the present disclosure, in the step of forming the upper tuck-in portion and the lower tuck-in portion, the upper tuck-in portion may be formed by adjusting a tuck-in amount thereof according to the size of a vehicle where the side air bag apparatus is installed, and the lower tuck-in portion may be formed to be spaced apart from the preset reference part by a preset distance.

In the present disclosure, in the step of forming the inboard folding portion, the inboard folding portion may be formed by adjusting a folding amount thereof according to the size of the vehicle where the side air bag apparatus is installed.

In the present disclosure, a deployment speed of the cushion part may be controlled according to the tuck-in amount of the upper tuck-in portion and the folding amount of the inboard folding portion.

In an embodiment, a side air bag apparatus includes a cushion part disposed between a passenger and a door trim, wherein the cushion part includes: an upper tuck-in portion and a lower tuck-in portion formed by tucking in one side of an upper chamber and one side of a lower chamber, respectively, the upper chamber and the lower chamber being divided by a preset reference part; an inboard folding portion formed by folding the upper chamber toward the preset reference part in a state in which the upper tuck-in portion has been formed; and a rolling portion formed by rolling, in a direction of an inflator, the upper chamber in a state in which the inboard folding portion has been formed and the lower chamber in a state in which the lower tuck-in portion has been formed.

In the present disclosure, the side air bag apparatus may further include a diaphragm part configured to divide the cushion part into an upper chamber and a lower chamber, wherein the preset reference part may be the diaphragm part.

In the present disclosure, the diaphragm part may be formed by a sewing method.

In the present disclosure, the preset reference part may be a central part of the cushion part, when the cushion part has a one-chamber structure, the cushion part may be divided into an upper chamber and a lower chamber by the central part.

In the present disclosure, the lower tuck-in portion may be formed to be spaced apart from the preset reference part by a preset distance.

In the present disclosure, a tuck-in amount of the upper tuck-in portion may be adjusted according to the size of a vehicle where the side air bag apparatus is installed.

In the present disclosure, a folding amount of the inboard folding portion may be adjusted according to the size of the vehicle where the side air bag apparatus is installed.

In the present disclosure, a deployment speed of the cushion part may be controlled according to the tuck-in amount of the upper tuck-in portion and the folding amount of the inboard folding portion.

According to the present disclosure, the tuck-in amount a of the upper tuck-in portion and the folding amount b of the inboard folding portion are adjusted according to the space (size) of a vehicle, so that it is possible to control the deployment speed of the side air bag apparatus, thereby substantially preventing a passenger's chest from being injured by the expansion pressure of the cushion part.

Effects of the present disclosure are not limited to the aforementioned effects and may include various effects within the range obvious to those skilled in the art from the following description.

### BRIEF DESCRIPTION OF THE DRAWINGS

FIG. 1 is a front view schematically illustrating a state in which a side air bag apparatus in accordance with an embodiment of the present disclosure is inflated toward one side of a seat.

FIG. 2 is a perspective view illustrating a state in which a cushion part is fully deployed in the side air bag apparatus in accordance with an embodiment of the present disclosure.

FIGS. 3A and 3B are views illustrating a state in which an upper tuck-in portion and a lower tuck-in portion are formed in accordance with an embodiment of the present disclosure.

FIGS. 4A and 4B are views illustrating a state in which an inboard folding portion is formed in accordance with an embodiment of the present disclosure.

FIG. 5 is a view illustrating a state in which a rolling portion is formed in accordance with an embodiment of the present disclosure.

FIG. 6 is a flowchart for explaining a folding method of the side air bag apparatus in accordance with an embodiment of the present disclosure.

FIG. 7 is a view for explaining an operation of the side air bag apparatus in accordance with an embodiment of the present disclosure.

FIG. 8 is a view illustrating a state in which the inboard folding portion is deployed in accordance with an embodiment of the present disclosure.

FIG. 9 is a view illustrating a state in which the tuck-in portions are deployed in accordance with an embodiment of the present disclosure.

### DETAILED DESCRIPTION OF THE ILLUSTRATED EMBODIMENTS

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, a folding method of a side air bag apparatus and the side air bag apparatus in accordance with an embodiment of the present disclosure will be described below with reference to the accompanying drawings. In this process, the thicknesses of lines or the sizes of elements illustrated in the drawings may be exaggerated for the purpose of clarity and convenience of explanation.

Furthermore, terms to be described later are terms defined in consideration of functions thereof in the present disclosure and may be changed according to the intention of a user or an operator, or practice. Accordingly, such terms should be defined based on the disclosure over the present specification.

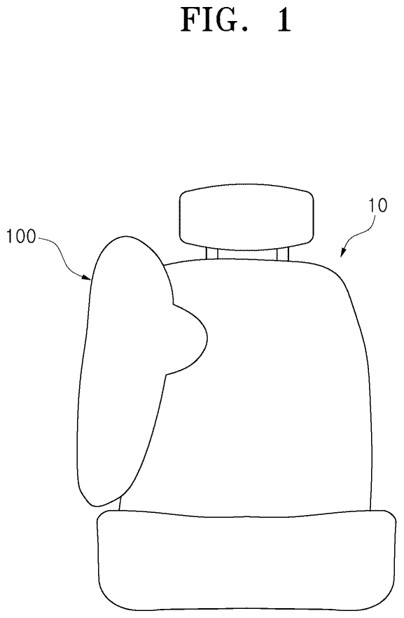

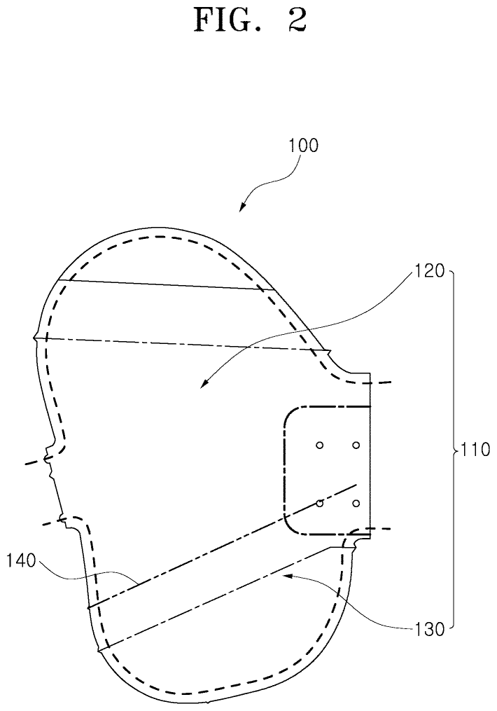

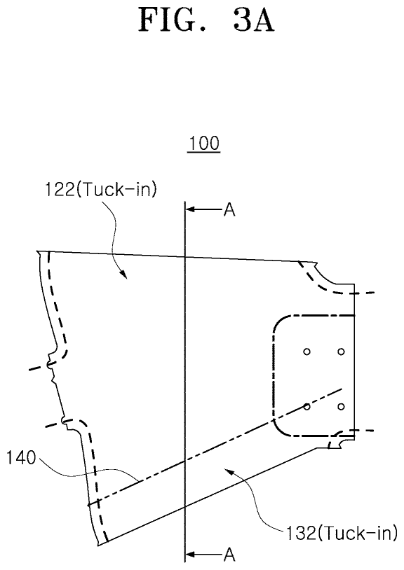

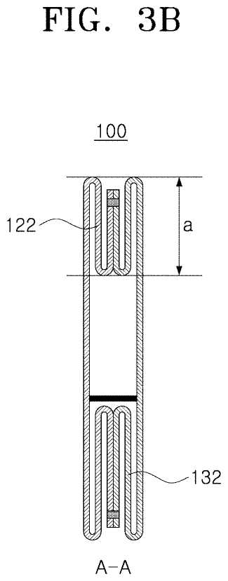

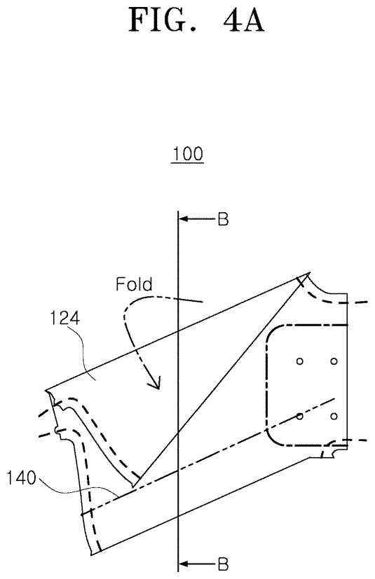

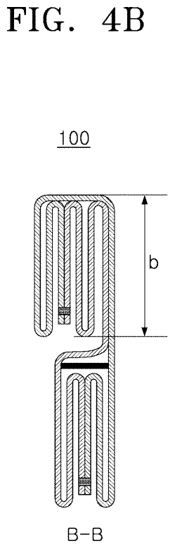

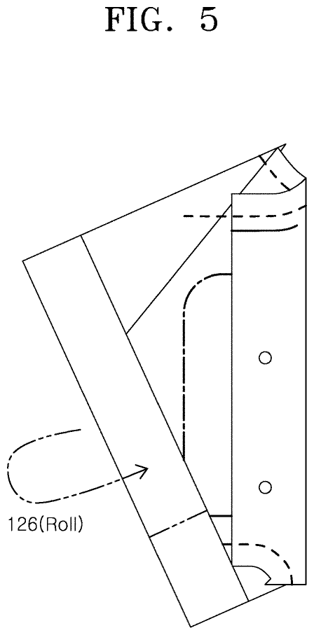

FIG. 1 is a front view schematically illustrating a state in which a side air bag apparatus in accordance with an embodiment of the present disclosure is inflated toward one side of a seat, FIG. 2 is a perspective view illustrating a state in which a cushion part is fully deployed in the side air bag apparatus in accordance with an embodiment of the present disclosure, FIGS. 3A and 3B are views illustrating a state in which an upper tuck-in portion and a lower tuck-in portion are formed in accordance with an embodiment of the present disclosure, FIGS. 4A and 4B are views illustrating a state in which an inboard folding portion is formed in accordance with an embodiment of the present disclosure, and FIG. 5 is a view illustrating a state in which a rolling portion is formed in accordance with an embodiment of the present disclosure.

Referring to FIG. 1 to FIG. 5, a side air bag apparatus 100 in accordance with an embodiment of the present disclosure includes a cushion part 110 and a diaphragm part 140.

The side air bag apparatus 100 is installed on the outside (outboard side) of a seat 10 on which a passenger sits. The cushion part 110 of the side air bag apparatus 100 is disposed between a passenger P and a door trim 5, and is inflated to cover the body of the passenger sitting in the seat 10. Such a cushion part 110 may be made of a synthetic fiber material.

The cushion part 110 includes an upper chamber 120 and a lower chamber 130. The cushion part 110 may be divided into the upper chamber 120 and the lower chamber 130 by the diaphragm part 140.

The upper chamber 120 is formed on an upper side (refer to FIG. 1) of the cushion part 110, and is disposed corresponding to the chest position of the passenger P.

Therefore, when gas G supplied from an inflator (not illustrated) flows into the upper chamber 120, the upper chamber 120 may absorb an impact applied to the chest side of the passenger by the upper chamber 120.

The lower chamber 130 is formed on a lower side (refer to FIG. 1) of the cushion part 110, and is disposed corresponding to a lower portion of the chest of the passenger, specifically, the pelvic position.

Therefore, when the gas G supplied from the inflator flows into the lower chamber 130, the lower chamber 130 may absorb an impact applied to the pelvic side of the passenger by the lower chamber 130.

The cushion part 110 configured as described above may have various shapes and may be formed by various folding methods within the technical scope in which the cushion part 110 is connected to the inflator (not illustrated), is inflated by receiving gas through the operation of the inflator, and forms a cushion that is deployed toward the body of the passenger. The cushion part 110 in accordance with an embodiment may be formed by a folding method of tucking in one side of the upper chamber 120 and one side of the lower chamber 130, folding the tucked-in upper chamber 120 inwardly, and rolling the folded upper chamber 120 and the tucked-in lower chamber 130 in the direction of the inflator.

The cushion part 110 includes a pair of tuck-in portions, an inboard folding portion 124, and a rolling portion 126.

The tuck-in portions include an upper tuck-in portion 122 and a lower tuck-in portion 132.

The upper tuck-in portion 122 is formed by tucking in one side of the upper chamber 120. At this time, the upper tuck-in portion 122 may be formed on a side where the diaphragm part 140 is not installed, that is, on the outside.

The upper tuck-in portion 122 may be formed into a ‘w’ shape as illustrated in FIG. 3B by putting one side of the upper chamber 120 inwardly. At this time, the tuck-in amount (folding amount) a of the upper tuck-in portion 122 may be adjusted according to the size of a vehicle where the side air bag apparatus 100 is installed. A passenger may lift his/her arm according to a tuck-in amount a of the upper tuck-in portion 122.

The lower tuck-in portion 132 is formed by tucking in one side of the lower chamber 130. At this time, the lower tuck-in portion 132 may be formed on the side where the diaphragm part 140 is not installed, that is, on the outside.

The lower tuck-in portion 132 may be formed into a ‘m’ shape as illustrated in FIG. 3B by putting one side of the lower chamber 130 inwardly. At this time, the lower tuck-in portion 132 may be formed to be spaced apart from the diaphragm part 140 by a preset distance. For example, the lower tuck-in portion 132 may be formed to be spaced apart from the diaphragm part 140 by 60 mm.

The inboard folding portion 124 is formed by folding the upper chamber 120 toward the diaphragm part 140 in the state in which the upper tuck-in portion 122 has been formed. That is, the inboard folding portion 124 may be formed by folding the tucked-in upper chamber 120 inwardly as illustrated in FIG. 4A. Then, the inboard folding portion 124 folded inwardly may be formed as illustrated in FIG. 4B. At this time, a folding amount b of the inboard folding portion 124 may be adjusted according to the size of a vehicle where the side air bag apparatus 100 is installed. A deployment speed of the cushion part 110 may be adjusted according to the folding amount of the inboard folding portion 124.

The rolling portion 126 is formed by rolling, in the direction of the inflator, the upper chamber 120 in the state in which the inboard folding portion 124 has been formed and the lower chamber 130 in the state in which the lower tuck-in portion 132 has been formed. That is, as illustrated in FIG. 5, the rolling portion 126 may be formed by rolling inwardly the upper chamber 120 in the state in which the inboard folding portion 124 has been formed and the lower chamber 130 in the state in which the lower tuck-in portion 132 has been formed.

The deployment speed of the cushion part 110 configured as described above may be controlled by adjusting the tuck-in amount a of the upper tuck-in portion 122 and the folding amount b of the inboard folding portion 124 according to the space in the vehicle.

The diaphragm part 140 divides the cushion part 110 into the upper chamber 120 and the lower chamber 130.

The diaphragm part 140 may be made of substantially the same material as that of the cushion part 110, specifically, a synthetic fiber material.

The diaphragm part 140 may be connected to the cushion part 110 by a sewing method, and may be coupled to the cushion part 110 by a sewing line, specifically, to an inner surface of the cushion part 110.

The diaphragm part 140 may not only allow the gas G to flow between the upper chamber 120 and the lower chamber 130, but also block the flow of the gas G from the lower chamber 130 to the upper chamber 120 or from the upper chamber 120 to the lower chamber 130.

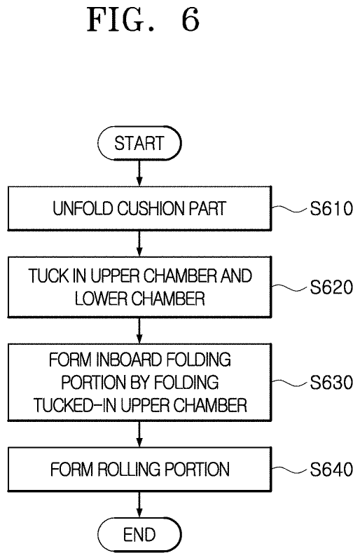

FIG. 6 is a flowchart for explaining a folding method of the side air bag apparatus in accordance with an embodiment of the present disclosure.

Referring to FIG. 6, the cushion part 110 of the side air bag apparatus 100 is unfolded (S610). At this time, the inflator is connected to the cushion part 110.

Then, the upper tuck-in portion 122 and the lower tuck-in portion 132 are formed by tucking in one side of the upper chamber 120 and one side of the lower chamber 130, which are divided by the diaphragm part 140, respectively (S620). At this time, the upper tuck-in portion 122 may be formed by adjusting its tuck-in amount according to the size of a vehicle where the side air bag apparatus 100 is installed, and the lower tuck-in portion 132 may be formed to be spaced apart from the diaphragm part 140 by a preset distance.

In the state in which the upper tuck-in portion 122 has been formed in step S620, the inboard folding portion 124 is formed by folding the upper chamber 120 toward the diaphragm part 140 (S630). At this time, the folding amount of the inboard folding portion 124 may be adjusted according to the size of a vehicle where the side air bag apparatus 100 is installed.

The rolling portion 126 is formed by rolling, in the direction of the inflator, the upper chamber 120, in the state in which the inboard folding portion 124 has been formed in step S630, and the lower chamber 130, in the state in which the lower tuck-in portion 132 has been formed (S640).

Hereinafter, an operation of the side air bag apparatus 100 in accordance with an embodiment of the present disclosure, which is installed as described above, will be described.

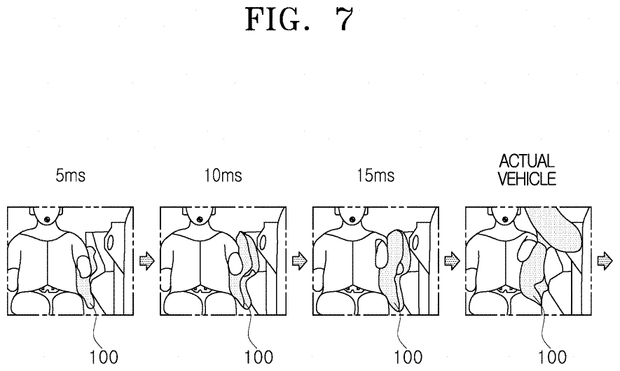

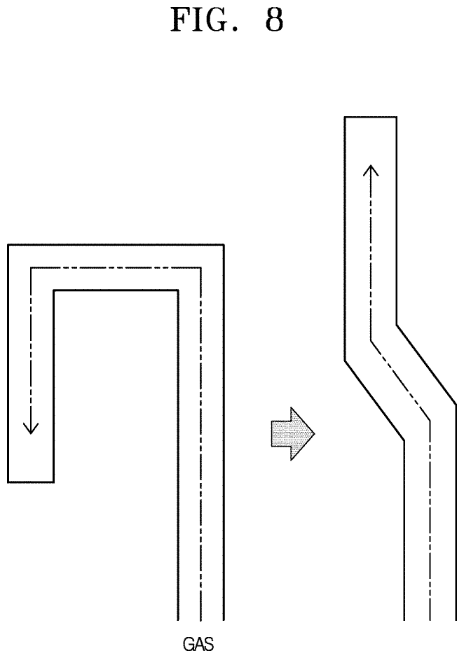

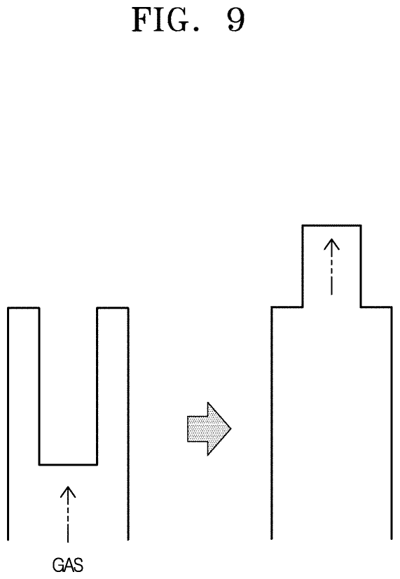

FIG. 7 is a view for explaining an operation of the side air bag apparatus in accordance with an embodiment of the present disclosure, FIG. 8 is a view illustrating a state in which the inboard folding portion is deployed in accordance with an embodiment of the present disclosure, and FIG. 9 is a view illustrating a state in which the tuck-in portions are deployed in accordance with an embodiment of the present disclosure.

Referring to FIG. 7 to FIG. 9, when a vehicle collides, gas is discharged from the inflator. Since a discharge part of the inflator is connected to the cushion part 110, the inboard folding portion 124 is deployed. At this time, the inboard folding portion 124 may be deployed as illustrated in FIG. 8. As the inboard folding portion 124 is deployed, a passenger may lift his/her arm.

When the inboard folding portion 124 is deployed, the upper tuck-in portion 122 and the lower tuck-in portion 132 are deployed. At this time, the upper tuck-in portion 122 and the lower tuck-in portion 132 may be deployed as illustrated in FIG. 9.

As described above, the folded portion of the inboard folding portion 124 is unfolded and the tuck-in portions are released, so that it is possible to improve the deployment speed of the side air bag apparatus 100.

In the above, although the case where the cushion part 110 has a two-chamber structure has been described, the aforementioned folding method may also be equally applied to a side air bag apparatus having one-chamber structure. In such a case, a cushion part of the side air bag apparatus may be divided into an upper chamber and a lower chamber by a central part thereof. At this time, the central part may be the center of the cushion part or a position corresponding to a passenger's abdomen. The cushion part 110 divided into the upper chamber 120 and the lower chamber 130 may be formed by a folding method of tucking in one side of the upper chamber 120 and one side of the lower chamber 130, folding the tucked-in upper chamber 120 inwardly, and rolling the folded upper chamber 120 and the tucked-in lower chamber 130 in the direction of the inflator. Since the folding method of the side air bag apparatus having one-chamber structure is substantially the same as that of the side air bag apparatus 100 having two-chamber structure, a detailed description thereof will be omitted.

As described above, according to the folding method of the side air bag apparatus 100 and the side air bag apparatus 100 in accordance with an embodiment of the present disclosure, the tuck-in amount a of the upper tuck-in portion 122 and the folding amount b of the inboard folding portion 124 are adjusted according to the space (size) of a vehicle, so that it is possible to control the deployment speed of the side air bag apparatus 100, thereby substantially preventing a passenger's chest from being injured by the expansion pressure of the cushion part 110.

Although the present disclosure have been described with reference to the embodiments illustrated in the drawings, the embodiments of the disclosure are for illustrative purposes only, and those skilled in the art will appreciate that various modifications and other equivalent embodiments are possible therefrom.

Thus, the true technical scope of the present disclosure should be defined by the following claims.

What is claimed is:

1. A folding method of a side air bag apparatus, the folding method comprising the steps of:
forming an upper tuck-in portion and a lower tuck-in portion by tucking in one side of an upper chamber and one side of a lower chamber of a cushion part, respectively, the upper chamber and the lower chamber being divided by a preset reference part;
forming an inboard folding portion by folding the upper chamber toward the preset reference part in a state in which the upper tuck-in portion has been formed; and
forming a rolling portion by rolling, in a direction of an inflator, the upper chamber in a state in which the inboard folding portion has been formed and the lower chamber in a state in which the lower tuck-in portion has been formed.

2. The folding method according to claim 1, wherein the preset reference part is a diaphragm part or a central part,
when the cushion part has a two-chamber structure, the cushion part is divided into an upper chamber and a lower chamber by the diaphragm part, and
when the cushion part has a one-chamber structure, the cushion part is divided into an upper chamber and a lower chamber by the central part.

3. The folding method according to claim 1, wherein, in the step of forming the upper tuck-in portion and the lower tuck-in portion, the upper tuck-in portion is formed by adjusting a tuck-in amount thereof according to a size of a vehicle where the side air bag apparatus is installed, and the lower tuck-in portion is formed to be spaced apart from the preset reference part by a preset distance.

4. The folding method according to claim 1, wherein, in the step of forming the inboard folding portion, the inboard folding portion is formed by adjusting a folding amount thereof according to the size of the vehicle where the side air bag apparatus is installed.

5. The folding method according to claim 1, wherein a deployment speed of the cushion part is controlled according to the tuck-in amount of the upper tuck-in portion and the folding amount of the inboard folding portion.

6. A side air bag apparatus comprising:
a cushion part disposed between a passenger and a door trim,
wherein the cushion part comprises:
an upper tuck-in portion and a lower tuck-in portion formed by tucking in one side of an upper chamber and one side of a lower chamber, respectively, the upper chamber and the lower chamber being divided by a preset reference part;
an inboard folding portion formed by folding the upper chamber toward the preset reference part in a state in which the upper tuck-in portion has been formed; and
a rolling portion formed by rolling, in a direction of an inflator, the upper chamber in a state in which the inboard folding portion has been formed and the lower chamber in a state in which the lower tuck-in portion has been formed.

7. The side air bag apparatus according to claim 6, further comprising:
a diaphragm part configured to divide the cushion part into an upper chamber and a lower chamber,
wherein the preset reference part is the diaphragm part.

8. The side air bag apparatus according to claim 7, wherein the diaphragm part is formed by a sewing method.

9. The side air bag apparatus according to claim 6, wherein the preset reference part is a central part of the cushion part,
when the cushion part has a one-chamber structure, the cushion part is divided into an upper chamber and a lower chamber by the central part.

10. The side air bag apparatus according to claim 6, wherein the lower tuck-in portion is formed to be spaced apart from the preset reference part by a preset distance.

11. The side air bag apparatus according to claim 6, wherein a tuck-in amount of the upper tuck-in portion is adjusted according to a size of a vehicle where the side air bag apparatus is installed.

12. The side air bag apparatus according to claim 6, wherein a folding amount of the inboard folding portion is adjusted according to the size of the vehicle where the side air bag apparatus is installed.

13. The side air bag apparatus according to claim 6, wherein a deployment speed of the cushion part is controlled according to the tuck-in amount of the upper tuck-in portion and the folding amount of the inboard folding portion.
